(19) United States
(12) Patent Application Publication
(10) Pub. No.: US 2020/0045929 A1
(43) Pub. Date: Feb. 13, 2020

(54) HOG HEALTH MONITOR

(71) Applicant: Krobel Corp, Janesville, MN (US)

(72) Inventors: Kenny Strobel, Janesville, MN (US); Ryan Kruse, Janesville, MN (US)

(21) Appl. No.: 16/536,447

(22) Filed: Aug. 9, 2019

Related U.S. Application Data
(60) Provisional application No. 62/716,616, filed on Aug. 9, 2018.
(60) Provisional application No. 62/860,999, filed on Jun. 13, 2019.

(51) Int. Cl. A01K 1/02; A61D 17/00

(52) U.S. Cl. CPC A01K 1/0218; G01V 8/10; A61D 17/008

(57) ABSTRACT

A monitoring system is used with one or more hogs in order to monitor the hogs. The system can monitor the health of the hogs to determine, predictively, if a change is occurring such that the change could be a health risk. The system can also determine farrowing, including the number of piglets and weight of the piglets. The system is capable of monitoring movement and eating patters to determine if a change has occurred that may signify a change in the health of the one or more hogs. The data of the system can be compiled and processed to allow the system to become self-learning in order to better predict and analyze the hog or hogs.

### CROSS REFERENCE TO RELATED APPLICATIONS

This application claims priority under 35 U.S.C. § 119 to provisional patent application U.S. Ser. Nos. 62/716,616, filed Aug. 9, 2018, and 62/860,999, filed Jun. 13, 2019. The provisional patent applications are herein incorporated by reference in their entirety, including without limitation, the specification, claims, and abstract, as well as any figures, tables, appendices, or drawings thereof.

### FIELD OF THE INVENTION

The invention relates generally to the field of animal monitoring. More particularly, but not exclusively, the invention relates to a system, method, and/or apparatus for monitoring and/or predictively determining a potential illness, health alert, status, change or other measurable characteristic in one or more animals.

### BACKGROUND OF THE INVENTIONS

Pig farming is the raising and breeding of domestic pigs as livestock. In developed nations, commercial farms house thousands of pigs in climate-controlled buildings. Pigs are a popular form of livestock, with more than one billion pigs butchered each year worldwide, 100 million of them in the USA. The majority of pigs are used for human food but also supply skin, fat, and other materials for use as clothing, ingredients for processed foods, cosmetics, and medical use.

Among the leading causes of hog (including, but not limited to, sows, market hogs, piglets, and boars) mortality are diseases. Currently, the standard way to determine a hog's health is to walk through the barn a few times a day and look at each hog for visible symptoms. Hog farming includes one or more people continuously and/or regularly monitoring hogs by physically checking the hogs in their environments to determine if any noticeable issues exist with one or more of the hogs. This can be labor and time intensive, especially with large scale hog farming operations. The one or more people generally walk adjacent or through the hogs to determine if there is any noticeable change in the health of a hog. This could indicate an illness or other health alert, such as, but not limited to farrowing, overheating, infection (viral or otherwise), or other indication that could affect one or more of the hogs.

Often, by the time a monitor has noticed such a change, the condition or health alert has become severe, elevating the emergency level and the need to expedite a response, which could include a local action, a veterinarian visit, or a trip to a place of care. Furthermore, the lack of a speedy notice could result in more than a single hog being affected. For example, if farrowing occurs and it is not noticed, the piglets could be affected. If a hog is inflicted with an infection or other transferable illness, by the time the situation is discovered, multiple hogs could be affected.

In addition, it may be important to track piglets (and sows and market hogs) after birth, in an attempt to make sure that the health of the animals remains positive. Thus far, to do so would require physical monitoring of the newly born piglets and identification if any of the piglets shows signs of illness or distress.

Late or hesitated response time to a health alert could end up in the mortality of one or more of the hogs, which could be mitigated if there were a way to determine early detection of an upcoming health alert to isolate and/or treat a hog. However, hiring additional people and/or veterinarians to provide continuous and around-the-clock monitoring of the hogs is expensive, if not impossible.

Therefore, there is a need in the art for a system, method, and/or apparatus that notifies farmers of potential health alerts for hogs or other animals, allowing for better treatment and containment.

### SUMMARY OF THE DISCLOSURE

Therefore, it is a principal object, feature, and/or advantage of the disclosed features to overcome the deficiencies in the art.

It is another object, feature, and/or advantage of the invention to provide a low-cost, easy-to-manufacture device to monitor one or more hogs from nursing to finishing.

It is still another object, feature, and/or advantage of the invention to notify farmers of potentially sick animals, allowing for better treatment and containment.

It is yet another object, feature, and/or advantage to provide a system, device, method, and/or apparatus that will limit human error, expand the types of diseases that can be caught, and provide for earlier identification of health issues.

It is a further object, feature, and/or advantage to provide a system, device, and/or apparatus to provide predictive determination related to a health alert of a hog, such as an illness or farrowing.

It is yet a further object, feature, and/or advantage to monitor living animals to determine if a change in health has occurred, and if so, to initiate a plan to address the identified issue.

It is yet another object, feature, and/or advantage to monitor or more animals to determine and evaluate a measurable characteristic of the one or more animals.

It is still yet a further object, feature, and/or advantage of the present invention to provide a safe, cost effective, and durable apparatus.

It is still yet a further object, feature, and/or advantage of the present invention to provide an apparatus that is aesthetically pleasing.

It is still yet a further object, feature, and/or advantage of the present invention to practice methods which facilitate use, manufacture, assembly, maintenance, and repair of an apparatus accomplishing some or all of the previously stated objectives.

It is still yet a further object, feature, and/or advantage of the present invention to incorporate the apparatus into a system accomplishing some or all of the previously stated objectives.

These and/or other objects, features, and advantages of the disclosure will be apparent to those skilled in the art. The present invention is not to be limited to or by these objects, features and advantages. No single embodiment need provide each and every object, feature, or advantage.

According to some embodiments, a system for monitoring the health of one or more hogs includes a monitoring device associated with a hog and/or area holding the hog, wherein the monitoring devices comprises: at least one sensor for sensing an aspect of the health of the hog, which may be any measurable characteristic associated with one or more hogs; and a communication device for communicating the sensed aspect of the health of the hog; and wherein the sensed aspect of the health of the hog is compared to known health data of the same or a similar hog to predictively determine a health alert of the hog.

According to additional embodiments, the monitoring device further comprises a housing for carrying the at least one sensor and the communication device.

Some additional embodiments include that the monitoring device further comprises a power source operatively connected to the device for providing power to the at least one sensor and the communication device.

Some embodiments include that the communication device comprises: a Bluetooth low energy device; a near field communication component; a radio frequency identification tag; a cellular device; a Wi-Fi enabled device; or some combination thereof.

Some embodiments include that the aspect of the health of the hog comprises: respiratory conditions of the hog; temperature conditions of the hog; heart rate of the hog; odor conditions of the hog; colorization of the hog; movement of the hog; a sound association with the hog; or some combination thereof.

At least some of the embodiments include that the monitoring device comprises an audio or visual member to indicate a change in the health of the hog.

At least some of the embodiments include a receiver for receiving the sensed aspect of the health of the hog, said receiver being remote from the communication device.

According to some embodiments, a method of monitoring the health of a hog includes obtaining health data of a hog over a period of time by use of a monitoring device on or around the hog; storing the obtained health data until a threshold time period has been met; reviewing the obtained health data from start point to the threshold time period to determine if a significant change has occurred; and alerting, via the monitoring device, if the significant change has occurred.

According to some embodiments, a system, method, and/or apparatus is provided that includes a sensing device to monitor one or more hogs. The sensing apparatus may be a video device, such as a camera or thermal camera. The sensing apparatus is used to monitor or determine a measurable characteristic of the one or more hogs, including, but not limited to, birthweight of piglets, frequency of feedings, movement patterns of the one or more hogs, temperature of the one or more hogs, count of piglets during farrowing and after, breathing patterns, and other characteristics, such as those related to market potential. The measured characteristic can be communicated in real time, such that a user can monitor, and/or can be communicated to a processor and memory such that the processor determines if any action needs taken based upon an assessed determination and evaluation of the sensed characteristic.

For example, this could be in the form of additional feedings needed in the birth weight and feeding patterns determine a piglet needs more nutrition. Still additionally, the sensed characteristic could alert to a health issue of the one or more hogs, including health issues around farrowing.

### BRIEF DESCRIPTION OF THE DRAWINGS

FIGS. 1A-1F are various views of a monitoring device according to embodiments and/or aspects of the invention.

FIG. 2 is a diagram showing components of monitoring devices for use in monitoring hog health according to aspects of the invention.

FIG. 3 is a flow diagram showing an exemplary process for monitoring a hog according to aspects of the invention.

FIG. 4 is another flow diagram.

FIG. 5 is a view of a hog and monitoring device according to some embodiments of the invention.

FIG. 6 is a view of a hog and monitoring device according to some embodiments of the invention.

FIG. 7 is a view of a hog and monitoring device according to some embodiments of the invention.

FIG. 8 is a view of a monitoring system according to some embodiments of the invention.

Various embodiments of the invention and related components are described in detail with reference to the drawings, wherein like reference numerals represent like parts throughout the several views. Reference to various embodiments does not limit the scope of the invention. Figures represented herein are not limitations to the various embodiments according to the invention and are presented for exemplary illustration of the invention.

### DETAILED DESCRIPTION OF THE INVENTION

The following definitions and introductory matters are provided to facilitate an understanding of the present invention. Unless defined otherwise, all technical and scientific terms used herein have the same meaning as commonly understood by one of ordinary skill in the art to which embodiments of the present invention pertain.

The terms “a,” “an,” and “the” include plural referents unless context clearly indicates otherwise. Similarly, the word “or” is intended to include “and” unless context clearly indicate otherwise. The word “or” means any one member of a particular list and also includes any combination of members of that list.

The terms “invention” or “present invention” as used herein are not intended to refer to any single embodiment of the particular invention but encompass all possible embodiments as described in the specification and the claims, including any combination of any components of any embodiments not specifically grouped or combined.

The term “about” as used herein refers to variation in the numerical quantities that can occur, for example, through typical measuring techniques and equipment, with respect to any quantifiable variable, including, but not limited to, mass, volume, time, distance, wave length, frequency, voltage, current, and electromagnetic field. Further, given solid and liquid handling procedures used in the real world, there is certain inadvertent error and variation that is likely through differences in the manufacture, source, or purity of the ingredients used to make the compositions or carry out the methods and the like. The claims include equivalents to the quantities whether or not modified by the term “about.”

The term “configured” describes an apparatus, system, or other structure that is constructed or configured to perform a particular task or to adopt a particular configuration. The term “configured” can be used interchangeably with other similar phrases such as constructed, arranged, adapted, manufactured, and the like.

Terms such as first, second, vertical, horizontal, top, bottom, upper, lower, front, rear, end, sides, concave, convex, and the like, are referenced according to the views presented. These terms are used only for purposes of description and are not limiting. Orientation of an object or a combination of objects may change without departing from the scope of the invention.

The apparatuses, systems, and/or methods of the present invention may comprise, consist essentially of, or consist of the components of the present invention described herein. The term “consisting essentially of” means that the apparatuses, systems, and methods may include additional components or steps, but only if the additional components or steps do not materially alter the basic and novel characteristics of the claimed apparatuses, systems, and methods.

As hog farms grow and the number of hogs on a farm continues to increase, the need to continuously monitor hogs increases. This could be for health alerts, farrowing, weight monitoring, movement patterns, feeding patterns, or other characteristics related to hogs. For example, certain health alerts may include, but are not limited to, illnesses, diseases, indications of farrowing, and/or other issues that could affect one or more hogs on or within the farm. Additional monitoring could include determining and tracking piglet weight, the feeding patterns (frequency, duration, etc.) of piglets, movement patterns of piglets or older hogs, temperature of piglets and other hogs, and even the number piglets and/or other hogs in an area. Ideally, the farmers would like to determine when a health alert may be occurring as early as possible, and even to predictively determine an upcoming health alert. This would allow for the isolation and/or treatment of a hog having a potential health alert, so as not to affect other hogs in and or around the farm.

This is especially pertinent during and before farrowing. In order to decrease the mortality rate associated with farrowing occurring and issues arising, it is desirable to know, as soon as possible, when farrowing has occurred, has started, or will occur. Currently, the process to determine hogs' health and to determine if farrowing has begun is to walk through the barn or other containment area where hogs (e.g., pregnant sows) are held occasionally and to look at each hog for visible symptoms, which could be something as obvious as noticing birthed piglets. This is less than desirable, though. For example, by the time the visible systems are at a level to which a human may notice them, the systems may have progressed to the point where more severe issues can arise. This could include an illness reaching a level beyond treatment, or farrowing occurring in which the hog is not able to be isolated into a farrowing area, such that the birthing of piglets is occurring in an undesirable location. Unknown farrowing could result in the death or other health issues associated with the sow or the piglets. The health alert, if an illness, could also be spread or could otherwise affect one or more other hogs, which could cause widespread issues. Still further, the time and number of people required to walk through, in, and/or around the containment areas is large, and can be great expenditures in costs and time in trying to find people willing and knowledgeable enough to perform the monitoring duties. Therefore, as will be understood, the present invention includes systems, methods, and/or apparatuses that provide for a way to monitor the health of hogs and to determine, either in real time or predictably, a health alert that could occur. The monitoring can be of a pregnant sow for health and/or farrowing, piglets at and after birth to monitor the continued health, and also market hogs, such as to continuously monitor the hogs for predictive or actual change in their health. Aspects of the invention will limit human error, expand the types of diseases and other health alerts that can be identified, initiate an intervention or other order to address a noted issue, predictively determine an issue before it arises, and/or can provide for earlier identification of said health alerts.

For example, aspects and embodiments of the invention include the use of a hog monitoring device 10. According to some embodiments, each hog will have or will be otherwise associated with its own device 10. The device 10 can store a hog's respiratory or other health information for a set amount of time, e. g., 10 days, which can be used to determine an expected or otherwise normalized health base line. During the monitoring of the hog with the device 10, if the device (or a computing component on or otherwise in communication with the device) determines that a hog's respiratory or other monitored condition is out of the expected range for a prolonged period of time, the device 10 can consider the hog as having potentially a health alert. By requiring a prolonged change in the monitored health determination of the hog, the device 10 can avoid false alarms caused by short term exercise or excitement or other condition which may provide for a false indication of a health alert.

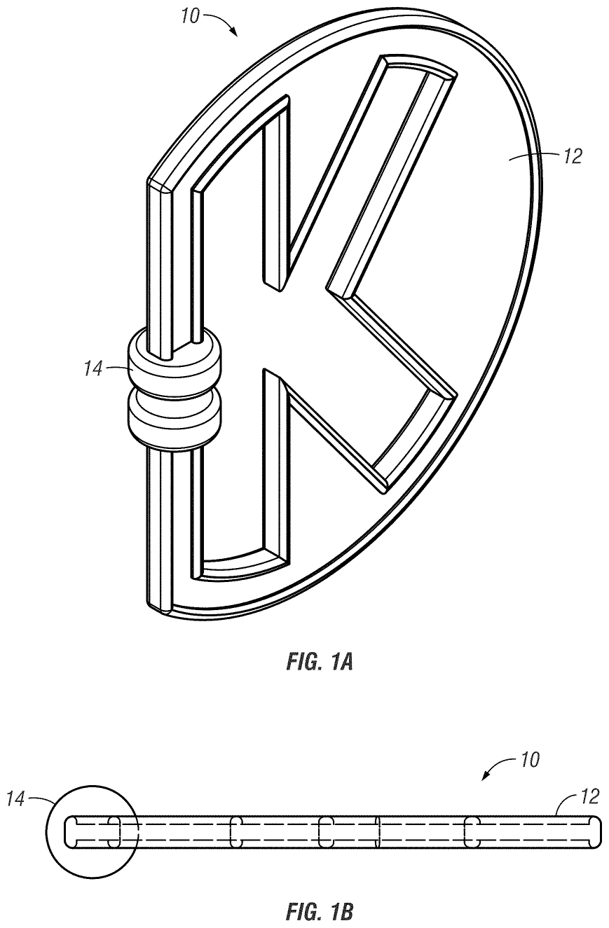

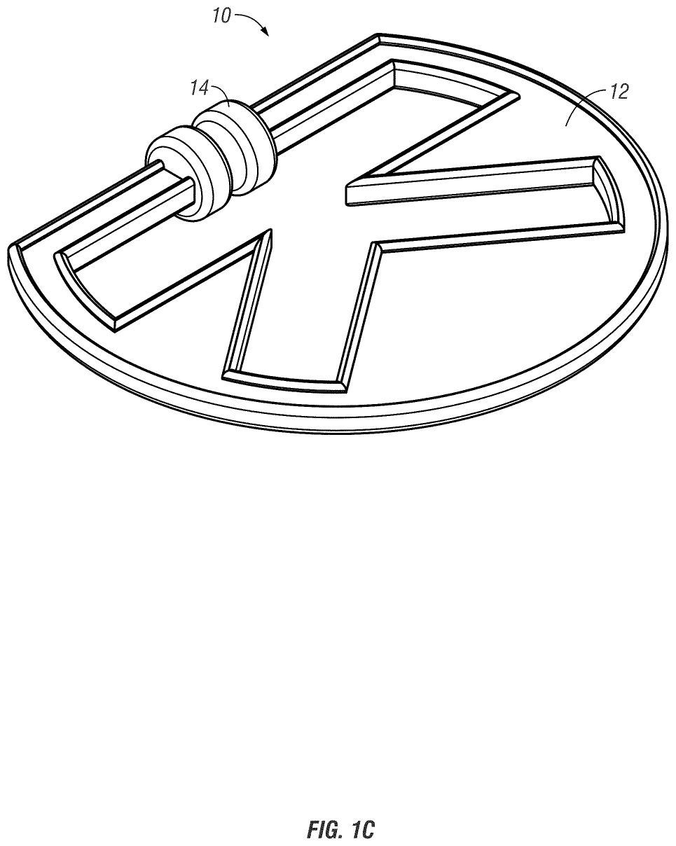

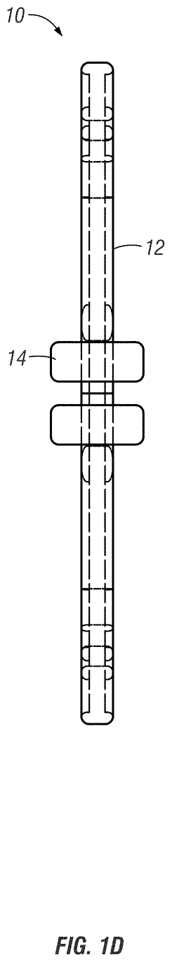

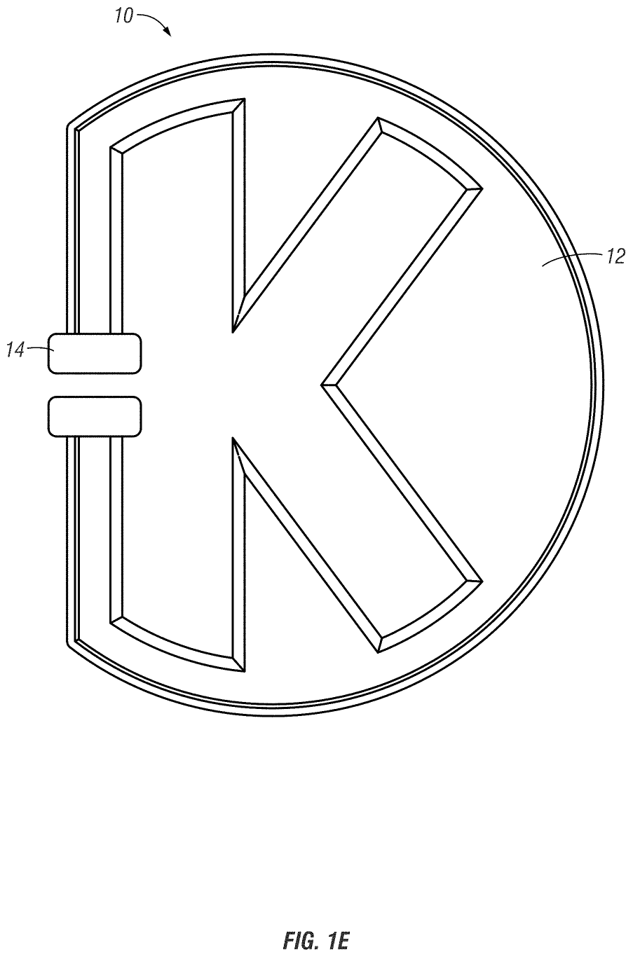

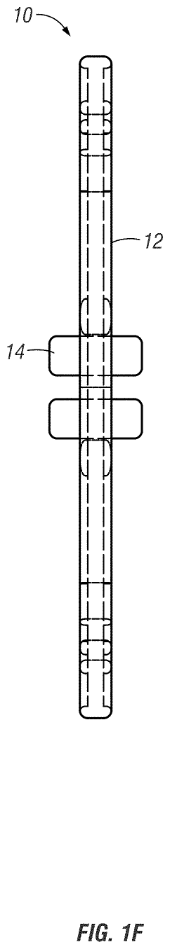

Exemplary embodiments of a health device 10 are shown in FIGS. 1A-1F. As can be understood, the monitoring device 10 can include a housing 12 and include a sensing apparatus 14. The housing can comprise a metallic material, polymer, plastic material, rubber material, or other synthetic material. The housing 12 can be used to house one or more of the components of the various embodiments and aspects of the present invention, and can be used as an attachment means for associating the monitoring device 10 with a hog, as will be understood. Furthermore, the housing may not take the shape and/or configuration as that shown in FIGS. 1A-1F, and can conceptually be of any shape, size, and/or connecting means in order to associate the monitoring device 10 with a hog.

The sensor can be generally any device capable of sensing a health aspect of a hog. For example, the sensor could be a respiratory device to monitor the respiratory rate of a particular hog. According to some embodiments, the sensor can be a thermometer other temperature sensing device in order to sense an external or internal or both external and internal temperature of the hog, to provide both a baseline and continuously updated temperature of the hog, in order to determine if a health alert has occurred. Other types of sensors can be moisture sensors, heart rate sensors, microphones, or the like. For example, it is contemplated that generally any sensor that can be used to monitor an aspect of health of a hog can be utilized and is intended to be incorporated as part of the invention. When a microphone is used, the microphone can be utilized to determine the sounds of breathing, or other noises of a hog, in order to determine if abnormal noises are occurring. Such abnormal noises could indicate a health alert and thus could be used to alert a farmer that a health alert is occurring or will potentially occur. The same could be done with a moisture sensor, such that increased moisture of a hog could indicate a health alert. Therefore, it is to be appreciative that generally any type of sensing apparatus that could indicate a potential change in the health of a hog is intended to be included as part of the invention, and it is also to be appreciated that the monitoring device 10 could include more than one sensing mechanism in order to sense multiple aspects of a hog's health in order to acquire information that can be used to predictably and/or monitor the health of a hog in order to determine if a health alert has or will be occurring.

Furthermore, as is understood and will be understood, the location of the sensor and/or sensors on the monitoring device 10 are not to be limiting. For example, when the monitoring device 10 is attached to a snout, the sensing apparatus could be positioned such that the sensors are within (fully or partially) the snout of the hog. When the monitoring device 10 is to be attached to an ear of a hog, the sensing mechanism 14 could be attached such that at least one of the sensing or sensors are positioned at least partially within an ear. As will be understood, the sensors could also be a placed in, on, or around a hog, such as in the proximity of a hog and not touching a hog such that data in the form of a hog's health can be monitored in order to determine if and when a health alert may be occurring.

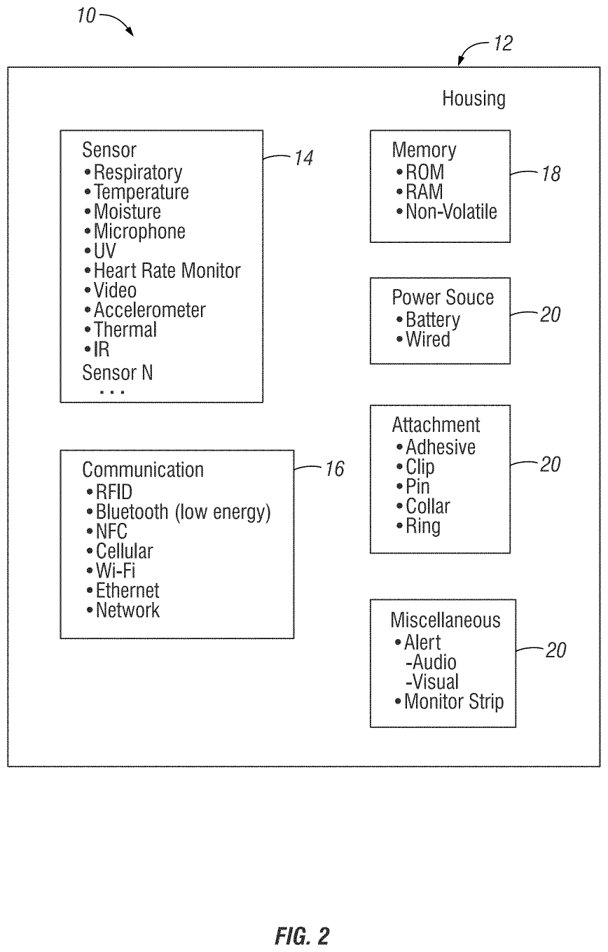

FIG. 2 is a schematic diagram of a monitoring device 10 including the various aspects and/or components of a monitoring device 10. It is to be appreciated that not all components shown in FIG. 2 need be included in a particular monitoring device 10, however, the various components as shown in the diagram of FIG. 2 could be combined in any combination and can be included and/or excluded in order to provide and/or monitoring device 10 that is desirable for use.

As disclosed, the monitoring device 10 can include a housing 12 taking many forms. And, on, within, and/or partially combined thereof can be sensing apparatuses 14, communication components 16, memory 18, power devices 20, attachment means 22, and/or other miscellaneous components 24. As disclosed, the sensing components can include one or more sensors, which is shown in FIG. 2 to be indicated by the Sensor1 as well as the SensorN, which is an indication that generally any number of sensors could be used with a particular monitoring device 10. As disclosed, types of sensors can include but are not limited to, respiratory sensors, temperature sensors, moisture sensors, microphone or other audio sensors, ultraviolet sensors, heart rate monitoring sensors, visual sensors (e.g., video cameras, thermal cameras, IR cameras, etc.), accelerometer sensors, and/or other types of sensors that can be indicative of a potential health alert.

The communications component 16 of the monitoring device 10 can be utilized to communicate the sensed information from the sensor component 14 and can send the sensed information to a user or a server for determining if a health alert has occurred. For example, the communication components can include an RFID component, a low energy Bluetooth component, a near field communication (NFC) component, a cellular component, a Wi-Fi component, and internet component, a network component, or some combination thereof. In some embodiments, the network is, by way of example only, a wide area network (“WAN”) such as a TCP/IP based network or a cellular network, a local area network (“LAN”), a neighborhood area network (“NAN”), a home area network (“HAN”), or a personal area network (“PAN”) employing any of a variety of communications protocols, such as Wi-Fi, Bluetooth, ZigBee, near field communication (“NFC”), etc., although other types of networks are possible and are contemplated herein. The network typically allows communication between the device and the central location during moments of low-quality connections. Communications through the network can be protected using one or more encryption techniques, such as those techniques provided in the IEEE 802.1 standard for port-based network security, pre-shared key, Extensible Authentication Protocol (“EAP”), Wired Equivalent Privacy (“WEP”), Temporal Key Integrity Protocol (“TKIP”), Wi-Fi Protected Access (“WPA”), and the like.

In some embodiments, a cloud-based network is used. A software licensing and delivery model for a cloud-based network could be software as a service (SaaS), infrastructure as a service (IaaS), platform as a service (PaaS), desktop as a service (DaaS), a managed service provider, mobile backend as a service (MBaaS), or information technology management as a service (ITMaaS).

The communications component can be associated with the one or more sensors of the monitoring device 10 and can communicate the sensed information to a server, tablet, cell phone, scanner, or other computing device including a processing unit in order to continuously update the sensed information for determination if a health alert is occurring or potentially may occur. This could be generally any processing unit (e.g., a processor, a microprocessor, a microcontroller, central processing unit (CPU), arithmetic logic unit (ALU))

Such information that has been communicated from the device to a remote location can then be analyzed, either by a human and/or by machine, and compared to determine if a health alert is occurring or may occur. Such an analysis may take place by a human reading and/or analyzing the data from the sensors and result time to determine if a health alert is occurring based upon comparison of the real time data in view of acquired data or can be analyzed utilizing machine learning. Machine learning (ML) is the scientific study of algorithms and statistical models that computer systems use to effectively perform a specific task without using explicit instructions, relying on patterns and inference instead. It is seen as a subset of artificial intelligence. Machine learning algorithms build a mathematical model of sample data, known as “training data”, in order to make predictions or decisions without being explicitly programmed to perform the task. The ML could be supervised or unsupervised, and can also be task-specific to determine the level of supervision. For example, if the communications mechanism delivers the sensed information to a server, algorithms, and/or other programmed in or on the server could be analyzing the data to determine if an abnormality has occurred. Such an abnormality could take the form of data being found outside a baseline analysis of data. This could create an alert to indicate that a health alert could be occurring. Such a health alert could be an increase in temperature or increase in respiratory rate that would be indicate that a potential illness, farrowing, or other issue via associated with a hog that needs to be examined by a farmer. As will be understood, other uses of the data could be included and contemplated to part of the disclosure as well. In addition, it should be appreciated that the system could be constantly receiving and reviewing data, which could improve the capabilities to begin earlier and even predictive analysis of when a health issue may be upcoming. This machine learning could always be adapting and looking for any sign that could be used to alert that the health issue has occurred or may be occurring in an attempt to isolate any issue and direct needed aid to the exact location without or with minimizing the waste of resources (veterinarians, farm help, etc.).

Furthermore, the baseline data and the continuously acquired data in the form of the sensed information (audio, video, biometric, other, or some combination thereof) could be delivered from the monitoring device 10 to a separate location in the form of memory or can be stored on the monitoring device 10 itself with memory 18 associated with the device 10. The memory, as will be understood could be in the form of ROM (non-volatile), RAM (volatile), semi-volatile, or nonvolant memory. Such memory could be tracked for an amount of time, and then delivered via the communications number two a separate memory location and/or could be stored continuously on the remote location wherein the sensed information it is continuously comparing the present or real time sensed information with the memory to determine if a health alert is occurring.

The memory includes, in some embodiments, a program storage area and a data storage area. The program storage area and the data storage area can include combinations of different types of memory, such as read-only memory (“ROM”, an example of non-volatile memory, meaning it does not lose data when it is not connected to a power source), random access memory (“RAM”, an example of volatile memory, meaning it will lose its data when not connected to a power source) Some examples of volatile memory include static RAM (“SRAM”), dynamic RAM (“DRAM”), synchronous DRAM (“SDRAM”), etc. Examples of non-volatile memory include electrically erasable programmable read only memory (“EEPROM”), flash memory, a hard disk, an SD card, etc. In some embodiments, the processing unit, such as a processor, a microprocessor, or a microcontroller, is connected to the memory and executes software instructions that are capable of being stored in a RAM of the memory (e.g., during execution), a ROM of the memory (e.g., on a generally permanent basis), or another non-transitory computer readable medium such as another memory or a disc.

In some embodiments, a device could include one or more communications ports such as Ethernet, serial advanced technology attachment (“SATA”), universal serial bus (“USB”), or integrated drive electronics (“IDE”), for transferring, receiving, or storing data.

Additional aspects of the monitoring device 10 could be a power source. The power source could be wireless in the form of battery of a battery, or could be a wired power source. The battery and/or wire source will be disclosed in greater detail herein.

The power supply outputs a particular voltage to a device or component or components of a device. The power supply could be a DC power supply (e.g., a battery), an AC power supply, a linear regulator, etc. The power supply can be configured with a microcontroller to receive power from other grid-independent power sources, such as a generator or solar panel.

With respect to batteries, a dry cell battery or a wet cell battery may be used. Additionally, the battery may be rechargeable, such as a lead-acid battery, a low self-discharge nickel metal hydride battery (LSD-NiMH) battery, a nickel-cadmium battery (NiCd), a lithium-ion battery, or a lithium-ion polymer (LiPo) battery. Careful attention should be taken if using a lithium-ion battery or a LiPo battery to avoid the risk of unexpected ignition from the heat generated by the battery. While such incidents are rare, they can be minimized via appropriate design, installation, procedures and layers of safeguards such that the risk is acceptable.

The power supply could also be driven by a power generating system, such as a dynamo using a commutator or through electromagnetic induction. Electromagnetic induction eliminates the need for batteries or dynamo systems but requires a magnet to be placed on a moving component of the system.

The power supply may also include an emergency stop feature, also known as a “kill switch,” to shut off the machinery in an emergency or any other safety mechanisms known to prevent injury to users of the machine. The emergency stop feature or other safety mechanisms may need user input or may use automatic sensors to detect and determine when to take a specific course of action for safety purposes.

Still further, the monitoring device 10 and/or the housing 12 thereof could include an attachment means 22. The attachment could be a way to attach the monitoring device or otherwise associate the monitoring device with a hog. Not limiting examples of attachment means could be an adhesive, a clip, a pen, a collar, or ring to associate the monitoring device 10 with a particular hog such that the monitoring device 10 is able to sense information via a sensor or sensors 14.

Still further, additional miscellaneous mechanisms 424 could be included with monitoring device 10 in order to provide the monitoring and alerting of a potential health alert of a hog. For example, the monitoring device 10 could include an alert in the form of an audio or visual number. For example, it is contemplated that the monitoring device 10 includes a small LED or other lighting device and receiver. This will provide a simple interface between the farmer and the device or devices 10. When a farmer is about to walk through the containment area of the hogs, a radio signal can be sent out to notify the one or more devices 10 via the receivers. The LED's will then be used to indicate to the farmer whether or not a corresponding hog has a potential health alert. This visual or feedback of the audio member will provide a quick and easy way for a farmer to be indicated that a potential health alert is occurring. Furthermore, the audio member, such as a speaker, could be included to provide an alarm or other mechanism to alert a farmer or if someone in a relative proximity to the device that a hog associated with the device is potentially undergoing a health alert. Still further, it is complicated that a monitoring strip could be included such that the monitoring strip changes color, form, or otherwise indicates to the farmer that a potential health alert is occurring such that the farmer need not look at the hog itself and can at said look at the device to be alerted of a potential health alert, which could be done in a manner to prevent additional harm to the hog or hogs.

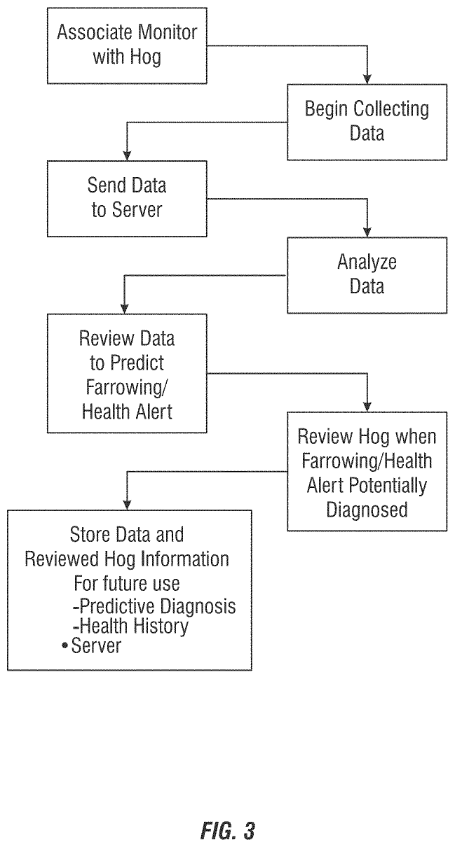

FIG. 3 is a flow diagram showing an exemplary process for monitoring one or more hogs according to aspects of the invention. According to the diagram of FIG. 3, a hog is first associated with a monitoring device. The hog is associated with the device by attaching a device to the hog or otherwise providing in proximity a device with a hog (i.e., associating a device with one or more hogs). Such a proximity device could be a camera or other imaging member, or a combination of one or more biometric sensors and an imaging device positioned in, on, or around a hog (such as at a pen). The device includes sensing components to start collecting data in the form of a health characteristic of a hog. This can include the respiratory rate, temperature (including, but not limited to a change in body temperature and/or the presence of a new body temperature), moisture, sounds, heart rate, movement, location, position (e.g., standing, laying, etc.), or other indications of a hog that may be indicative of the health of said hog. As the data is collected, it will continuously send the data via the communication device to a server or other computing device. Such a computing device, as will be understood, can include any processing member, including but not limited to, servers, computers, cell phones, tablets, readers, or the like. A person or the machine itself will begin reviewing the data compared to some baseline data to determine if any anomaly has occurred. The anomaly could be indicative of a potential health alert, including farrowing, illness, disease, overheating, food borne sickness, or the like. If it is determined that a potential health alert has occurred, based upon the review of said data, a hog can be separated and/or examined to determine if the health alert is actually occurring. In addition, the data that was sent to the remote location can be stored and reviewed for future use, such as predictive prognosis, health history, or the like. For example, if it is determined that a particular sort of sensed data continuously matches a health alert, such as farrowing, the machine can learn and can provide for more accurate indication of the health alert occurring, which can improve the efficiency in application of the device for use with the hog.

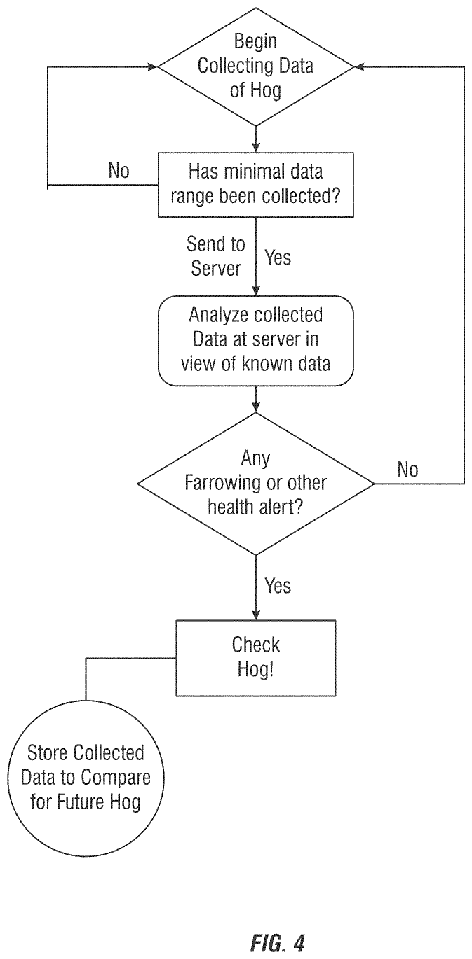

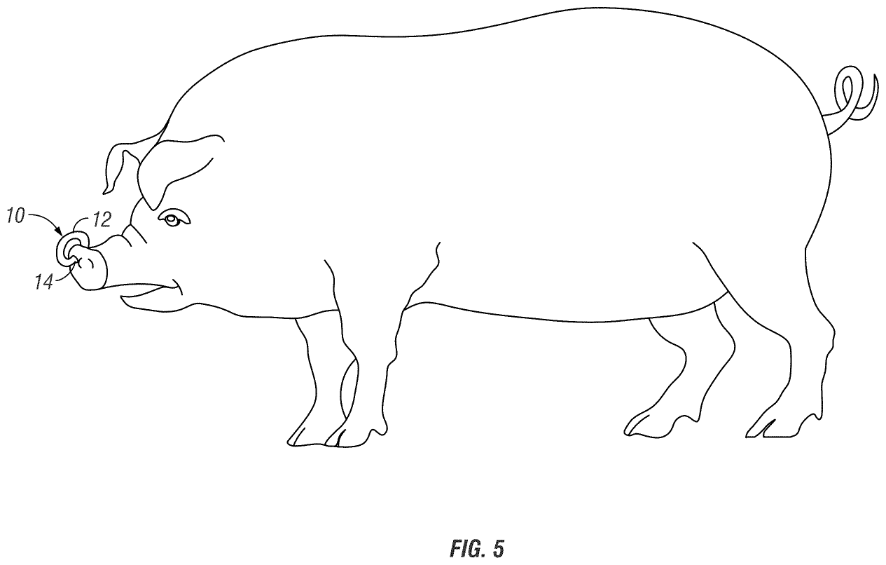

FIG. 4 is yet another flow diagram for showing and/or describing aspects of the invention. As noted, a device is associated with the hog and data is collected for the hog. Such data relates to health information that is sent by the device. At the next step, it is determined whether a minimal amount of data range has been collected. For example, according to some aspects of the invention, it is desired that the respiratory rate for at least ten days be a minimal amount of data to determine a baseline for a hog (however, other minimal amounts of data may be in the form of something other than time duration, such as number of heart beats, breaths, or other baseline data threshold). After the ten days, the data can be viewed, and it can be determined if there are any abnormalities from said baseline. Therefore, it is asked has the minimal amount of data been collected. It is noted that this could also be a lesser amount of data, such milliseconds, microseconds, or less. If the answer is no, data is continued to be collected and/or remotely delivered to a remote location. If it has been determined that enough data has been acquired via the monitoring device, the device is sent to a server or other location and is analyzed in view of the base line or known information in the form of health data. The analyzed data is determined to see if farrowing or other health alerts have occurred based upon any potential abnormalities or anomalies in viewing and comparing the acquired data over the more than minimal amount of range of the collected data. The analysis can be in the form of machine learning to determine correlations between one or more aspects of the health being sensed and a particular health alert, and/or could be manually reviewed. If no health alert has been detected, the data is continued to be collected and the process is repeated. However, if some sort of an abnormality and/or anomaly is detected, an alert is provided, and the hog is checked and examined to determine the health alert. Furthermore, the collected data can be stored and compared for future use with the same hog, similar hog, or other hogs.

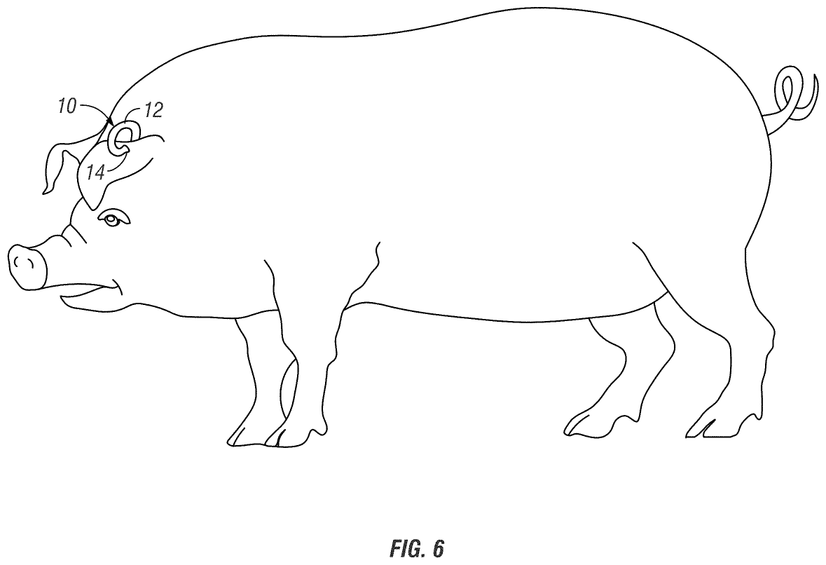

FIGS. 5-8 provide embodiments of the monitoring device 10. It is to be appreciated that the embodiments shown in the figures are not limiting and are not restrictive to this disclosure herein, and instead are used for exemplary and/or illustrated purposes to provide an understanding and potential use for the monitoring device of the invention. Therefore, FIG. 5 provides an attachable sensing device 10 attached to a hog snout. The sensing device shown in FIG. 5 can be a respiratory sensor sensing the respiratory rate, temperature, or other aspect of the breathing and respiratory aspects of a hog. It is attached in any manner, such as a nose ring or other attachment means to hold the device 10 at the snout. For example, the sensor 14 can be molded into the housing 12 and can include a replaceable battery. A thermistor can be used to sense respirations of the hog. The device, according to some aspects and/or embodiments can be attached when a sow enters into a farrowing stall and can be utilized to determine if the sow is going to begin farrowing. The device 10 can be detachable once the sow farrows. According to some aspects, the device can last up to six months or even a year depending on the battery efficiency as it will be understood. The communication aspects of the device of FIG. 5 can be a Bluetooth low energy enabled device that communicates the sense data to a remote location. Furthermore, the device could include a near field communication component for scanning such as by a farmer walking in, around, or through a containment area.

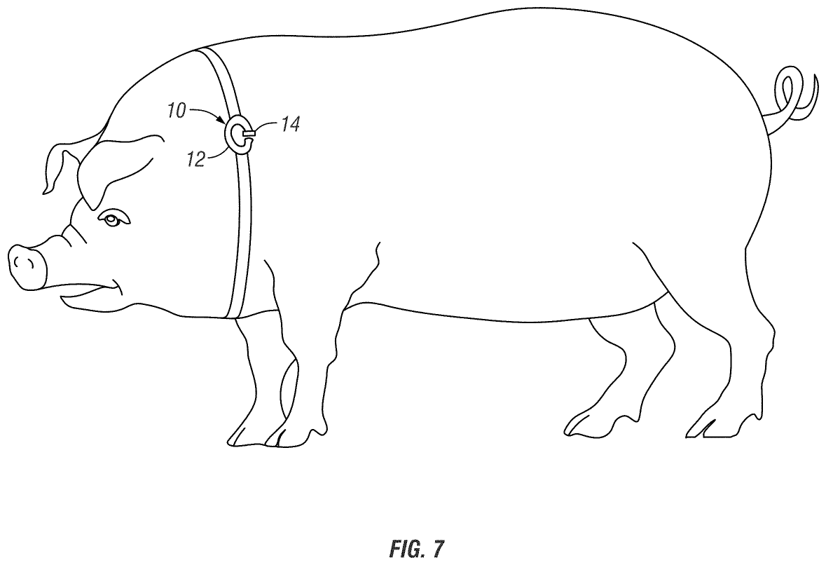

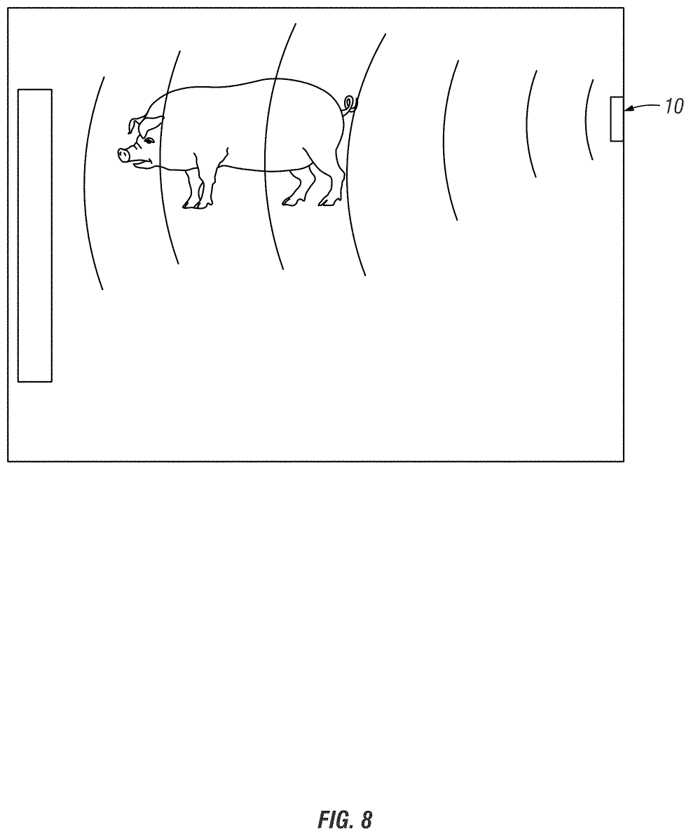

FIG. 6 shows another attachable device 10 which is attached to a sow's ear. Such a device will be removable. The device 10 includes a housing 12 and sense of apparatus 14. The housing 12 can be such that the device 10 is physically attached to the ear or otherwise adhesively attached to the back of the ear to determine the body temperature of the sow. The sensor or additional sensor could also be included to possibly determine heart rate of the sow as well, which could be utilized to indicate potential farrowing by the sow. Such a location of a sensor could ideally be placed behind the sow's ear. The device 10 could be powered by battery or could be hard wired. Hard wiring the device could allow the device to last up to possibly two years before replacement is required. Additionally, the communication aspects of the device 10 could be Bluetooth or NFC or otherwise communicable as will be understood by the communication devices disclosed herein. FIG. 7 is yet another embodiment showing an attachable and removable collar 22 including a monitoring device 10. The monitoring device itself includes the housing 12 and sensing apparatus 14. The monitoring device 10 can be attached to a collar 22 which is wrapped around a portion of the hog to monitor aspects thereof. For example, the monitoring device 10 can detect respiratory rate inward body temperature and/or heart rate of the hog, all which could provide possible indications of a health alert of the hog. Additional components can be Bluetooth communication, near field communication, or the like. Still further, a microphone could be utilized to sense the respiration, and/or an accelerometer or other device could be utilized to determine or sense the expansion of the throat of the hog. Abnormalities or anomalies of the movement could determine a health alert or potential health alert. Such health alerts could be determined by the machine learning or someone analyzing the data to determine if there is change from the baseline. The device 10 shown in FIG. 7 could be powered by a replacement battery, hard wired, or rechargeable battery, such as lithium ion battery.

FIG. 8 shows yet additional embodiments of the invention. As shown in FIG. 8, the device 10 is not attached to a hog, but is instead placed in proximity of the hog, such as on a farrowing stall. The device can be electrically powered in a hard wire manner, such as a plug and/or above the farrowing stall. The proximity sensor, such as shown by the waves of FIG. 8, could detect the body temperature of a hog and abnormalities wherein anomalies of the body temperature could indicate the health alert, such as farrowing, illness, disease, or other unwanted or undesirable health of the hog. The heart rate and/or respiratory rates could also be determined with such a proximity sensor. Therefore, the aspects as disclosed herein have provided numerous advantages over the visual examination of hogs by walking through a containment area including one or more hogs. The device is monitoring one or more health aspects of a hog can quickly and in real time determine if an anomaly and/or abnormality has occurred in comparison to some baseline information, which can indicate a health alert occurring or potentially occurring in the near future. This can greatly reduce the monitoring and can quickly and easily indicate potential issues which can be quelled before they become issues. The device can include and improve the mortality rate of hogs and piglets, which can provide for better life of the hogs and farming thereof. Additional aspects, ventures, and improvements obviously those skilled in the art are to be included.

According to additional embodiments, which could be similar to that shown in FIG. 8, one or more monitoring devices could be utilized such that the devices are associated with one or multiple hogs for monitoring. The monitoring devices could be positioned above multiple containment areas, such as on tracks, rails, roofs, or the like, such that the devices could be propagating or otherwise broadcasting a signal covering the multiple areas. For example, a camera could be used to view the multiple areas, and a person or machine learning could be used to determine or “notice” a change in corresponding pictures to determine if an alert, such as farrowing, has occurred. According to some embodiments, a thermal camera is used to take a picture of the sow and then the picture can be sent to a person or machine to process the image to see if there are piglets in it. A thermal camera could also be used to get, monitor, and determine the temperature changes in a sow's body temperature, which could be indicative of farrowing or another health alert. These sensors may be on a track/rail above the sows, allowing one sensor to take pictures of every sow in a room. As noted, the pictures could be reviewed by a person at a remote location, or could be sent in a closed loop system to a machine including logic that continuously compares current pictures with previous ones to determine if any change has occurred that could correlate to a health alert, such as farrowing. For example, the images could show the birthing of piglets by noticing the heat of animals that were not in previous images. The system could include an alert or indicator, such as a visual or audio indicator, that could alert a user to check on the hog or hogs being monitored.

For example, as will be understood with respect to Example III herein, the system could utilize imaging devices, such as cameras and/or thermal cameras. The system could evaluate pregnant sows, sows, postpartum piglets, market hogs, boars, or other living animals. The system can be utilized to identify the animals, including any location, biometric, movement, positioning of the animals. Such a use, as will be understood, can then be processed to determine an actual and/or a predictive issue.

The monitoring of the animal or animals could take many forms, and may be used for data acquisition, monitoring, predictive analysis, modeling, computational information, or some combination thereof. For example, according to any of the embodiments disclosed in the specification, information, such as a measurable characteristic, could be acquired by any system disclosed. During farrowing, the measurable characteristic could be one or more of the number of piglets born, the predicted or actual weight of the piglets/sows, the temperature of the piglets/sows, or the like. The weight of the piglets can be determined by scale or other measuring device, or could be predicted based upon factors such as measurable sizes of portions of the piglet. If a low weight piglet is determined, the piglet could be flagged to receive additional feedings or could otherwise be monitored for potential health issues. In addition, the number of feedings of the piglets could also be monitored and tracked. The information could be useful for health purposes and also for market potential for the pigs.

Additional measurable characteristics could include measuring movement patterns of piglets, sows, and other hogs. The movement patterns could be stored, evaluated, and monitored for predictive purposes to determine if an issue, such as a health issue or farrowing, will occur. The predictive analysis could provide foresight to let an operator know to be present or to check on a hog. Movement patterns can be accumulated, and a processor can review past patterns and outcomes of the patterns (e.g., farrowing, good health, negative health, disease, illness, etc.) such that the machine learning will provide a notice to an operator of a potential issue arising from the noticed movement patterns of a hog in a pen or other area. This could be done for a pregnant sow, one or more piglets, or other hogs.

Another measurable characteristic that will provide advantageous information is the temperature of one or more hogs in a pen. This could be the temperature of a sow, piglets, or other hogs. The piglet temperature can indicate mortality, illness, or even the presence of a piglet. A sow's temperature could indicate upcoming farrowing, illness, or other health issues.

Therefore, any type of measurable characteristic by a sensing means (e.g., video device, camera, thermal device, thermal imaging device, scale, thermometer, thermistor, proximity sensor, any other sensor mentioned herein or otherwise obvious to one skilled in the art, etc.) could be used to acquire the information and communicate the information to a processor for potential storage and analysis, such as by machine learning or other predictive analysis.

### Example I—Predictive Farrowing

The following is an example of how one or more of the embodiments could be used to determine farrowing. First, enough vital signs data must be collected from sows in farrowing stalls to establish ‘prediction patterns’ that indicate when farrowing is about to occur. The prediction patterns could be taken from a monitored hog or established via AI/machine learning from other hogs. Vital signs data is to be collected from the sow about 1-7 days before farrowing (typically when the sow is moved into the farrowing stall). The data is to be sent to a server where it is analyzed. The farrowing time may be predicted using machine learning. Otherwise, the farrowing time may be predicted based on changes in the vital signs such as, but not limited to: a sudden increase, peak, and decrease in heart rate; a change in body temperature (e.g., a 3-degree spike in body temperature followed by a 1-degree spike); an increase of respiratory rate to 80 bpm followed by a gradual decrease to 40 bpm; and/or movement patterns.

### Example II—Real Time Farrowing

In addition to the predictive elements, the monitoring device of any of the embodiments as disclosed herein could be used for real time monitoring of farrowing. For example, if a device is used that is not on the hog, but in proximity of the hog, the device could be a visual type device, such as a thermal imaging device/camera. The device could continuously take “pictures” or videos of the containment area holding a pregnant sow and to continuously analyze the data. The thermal imaging will be able to determine if one or more piglets is born by noticing a change in the thermal picture, such as by the addition of more animals. This will indicate farrowing has occurred, and an alert, such as in the form of an indicator light, visual or audio alarm, or otherwise, could alert a person to physically check the containment area and to address the situation. As noted, there could be a singular device for each hog in each containment area, or there could be one or more visual devices on tracks or otherwise mounted above multiple containment areas to continuously monitor multiple sows at a time by having the viewing spectrum broad enough to capture the multiple containment areas for any changes/alerts.

### Example III—Monitoring of Living Animals

In a situation similar to that of FIG. 8, a sensor or sensors could be used to acquire information. Such sensors could include, but are not limited to, visual sensors (cameras, IR cameras, thermal imaging cameras, etc.), audio sensors, thermometers, moisture sensors, odor detectors, motion detectors, or some combination thereof. The sensors can be used to acquire images of the sows and piglets (and market hogs or other animals). Those images are processed to identify piglet, sow, and market hog information, such as location, temperature, position (standing, laying, etc.), biometric data, feeding frequency, and more. That information is used to identify existing problems and/or potential problems, such as by predictive modeling. For piglets, these problems include, but are not limited to, isolation, low/high temperature, lack of movement, lack of feeding, crushing, getting stuck, illness, and more. For sows, these problems include, but are not limited to, lack of movement, piglets stuck during birth, irregular breathing, low/high temperature, movement indicating problems, illness, lack of feeding, and more. For market hogs, these problems include, but are not limited to, isolation, coughing, low/high temperature, lack of movement, lack of feeding, lack of water, movement indicating problems, irregular breathing, illness, and more.

The acquired data can then be collected, processed, and analyzed. Based on the conclusions from the analysis, the system may initiate some sort of intervention to solve the problem. This intervention could be initiated by alerting a human to assist the animals. The intervention could also be initiated by alerting another system to intervene.

It is to be appreciated that such a system can be used to both identify existing issues of the animals being monitored, and also to predictively determine the potential for an otherwise unknown issue. For example, as the system can incorporate updates, such as user implemented and/or machine learning, the data will continuously be monitored to attempt to identify indicators of issues. This could be in the form of a biometric trend that indicates an upcoming illness, farrowing, or the like, or could be movement or breathing based. The audio sensors could also be adapted to notice minute differences in sounds coming from one or more animals, and the sounds could be stored, analyzed, and learned to identify a change in a condition of the animal based upon the sound. Such a change could indicate the need for an intervention, or at the very least, additional investigation.

Therefore, a health monitoring device has been shown and described. The health monitoring device is contemplated to include obvious changes thereto (such as for use with animals other than pigs, i.e., other livestock) and it is also to be appreciated that any of the aspects disclosed herein be combined with any of the other aspects to utilize together or in singularly to acquire the data, send the data, analyze the data, and/or otherwise increase the efficiency of monitoring of hog health.

1. A system for monitoring a measurable characteristic of one or more hogs, the system comprising:
a device associated with a hog, wherein the devices comprises:
at least one sensor for sensing the measurable characteristic of the hog; and
a communication device for communicating the measurable characteristic of the hog; and
wherein the measurable characteristic of the hog is compared to known data of the same or a similar hog.

2. The system of claim 1, wherein the device further comprises a housing for carrying the at least one sensor and the communication device.

3. The system of claim 2, wherein the device further comprises a power source operatively connected to the device for providing power to the at least one sensor and the communication device.

4. The system of claim 1, wherein the communication device comprises:
a. a Bluetooth low energy device;
b. a near field communication component;
c. a radio frequency identification tag;
d. a cellular device;
e. a Wi-Fi enabled device; or
f. some combination thereof.

5. The system of claim 1, wherein the measurable characteristic of the hog comprises:
a. respiratory conditions of the hog;
b. temperature conditions of the hog;
c. heart rate of the hog;
d. odor conditions of the hog;
e. colorization of the hog;
f. movement of the hog;
g. a sound association with the hog;
h. a pattern of movement of the hog;
i. a number of hogs;
j. a feeding pattern;
k. a weight of the hog;
l. a size of the hog; or
m. some combination thereof.

6. The system of claim 1, wherein the device comprises an audio member to indicate a change in the health of the hog.

7. The system of claim 1, wherein the device comprises a visual member to indicate a change in the health of the hog.

8. The system of claim 1, further comprising a receiver for receiving the measurable characteristic of the hog, said receiver being remote from the communication device.

9. The system of claim 1, wherein the at least one sensor comprises:
a. a respiratory sensor,
b. a temperature sensor,
c. a moisture sensor,
d. a microphone or other audio sensor,
e. an ultraviolet sensor,
f. a heart rate monitoring sensor,
g. a video camera,
h. a thermal camera,
i. an IR camera,
j. an accelerometer sensor, or
k. some combination thereof.

10. A method of monitoring one or more hogs, comprising:
obtaining a measurable characteristic of the one or more hogs over a period of time by use of a monitoring device on or around the hog;
storing the obtained measurable characteristic until a threshold time period has been met;
reviewing the obtained measurable characteristic from a start point to the threshold time period to determine if the measurable characteristic is outside an acceptable data set; and
alerting, via the monitoring device, if the measurable characteristic is outside the acceptable data set.

11. The method of claim 10, further comprising communicating the measurable characteristic to a memory and processor.

12. The method of claim 11, wherein the step of reviewing the obtained measurable characteristic is done on the processor.

13. The method of claim 12, further comprising comparing the measurable characteristic with stored data to determine if the measurable characteristic is outside the acceptable data set.

14. The method of claim 10, wherein the measurable characteristic being outside the acceptable data set potentially indicates a health issue, a low weight, farrowing, a feeding, a change in the number of hogs, a change in temperature of the one or more hogs, or a change in a movement pattern of the one or more hogs.

15. The method of claim 10, further comprising repeating the steps of obtaining, storing, reviewing, and alerting for additional time periods to continue the monitoring of the one or more hogs.

16. A system for monitoring one or more hogs, comprising:
an enclosed area holding the one or more hogs;
a device associated with the enclosed area, the device used for acquiring a measurable characteristic of the one or more hogs; and
a processor used to receive the measurable characteristic of the one or more hogs, the processor configured to compare the measurable characteristic with stored data to determine an event.

17. The system of claim 16, wherein the event comprises:
a. a health alert;
b. an illness;
c. farrowing;
d. a change in movement patterns;
e. a change in feeding patterns;
f. a change in temperature;
g. a change in the number of hogs;
h. a change in breathing patterns;
i. a change in heart rate; or
j. a change in weight.

18. The system of claim 16, further comprising an alert system in communication with the processor and configured to emit an alert upon the event.

19. The system of claim 18, wherein the alert is audio or visual.

20. The system of claim 16, wherein the device is positioned at the enclosed area and not on the one or more hogs.
